(19) United States
(12) Patent Application Publication
(10) Pub. No.: US 2018/0226174 A1
(43) Pub. Date: Aug. 9, 2018

(54) WIRELINE OPERATIONS WITH COMPACTED CONDUCTER(S)

(71) Applicant: Halliburton Energy Services, Inc, Houston, TX (US)

(72) Inventor: Lawrence Charles Rose, Huntsville, TX (US)

(21) Appl. No.: 15/503,154

(22) PCT Filed: Oct. 28, 2015
(86) PCT No.: PCT/US2015/057831

§ 371 Date: Feb. 10, 2017

(51) Int. Cl. H01B 7/00; H01B 1/02; H01B 7/02; H01B 7/17; H01B 13/02; H01B 13/00; H02G 11/02; E21B 17/00; E21B 47/12

(52) U.S. Cl. CPC H01B 7/0009; H01B 1/02; H01B 7/02; H01B 7/17; E21B 19/008; H01B 13/0006; H02G 11/02; E21B 17/003; E21B 47/12; H01B 13/02

(57) ABSTRACT

A system, cable, and method for wireline operations are disclosed, in which a wireline cable may include one or more electrical wire having a compact stranded conductor, a first dielectric layer formed about the first electrical wire, and a strength member. The compact strands provide for increasing conductor size, increasing dielectric layer thickness, increasing armor size, and/or decreasing cable outer diameter. These parameters may be varied and optimized to provide specific wireline cable designs for particular wireline purposes. As compared to a conventional wireline cable employing uncompacted stranded conductors, the electrical resistance of the wireline cable may be lowered, the capacitance may be lowered, the operating temperature may be lowered, the outer diameter and weight may be lowered, and/or the tensile strength may be increased.

pressure control in the wellbore may be hampered due to greater void area in the armor package of the wireline cable.

### BRIEF DESCRIPTION OF THE DRAWINGS

Embodiments are described in detail hereinafter with reference to the accompanying figures, in which:

FIG. 1 is a block-level schematic diagram of a well logging system according to an embodiment, showing a wireline tool suspended by wireline in a well;

FIG. 2A is a transverse cross-section of a seven-conductor wireline cable of typical construction using characterized by uncompressed stranded electrical wires;

FIG. 2B is a transverse cross-section of a seven-conductor wireline cable of according to an embodiment having electrical wires with compressed strands and increased dielectric layer thickness compared to the wireline cable of FIG. 2A;

FIG. 2C is a transverse cross-section of a seven-conductor wireline cable of according to an embodiment having electrical wires with compressed strands and an overall reduced outer diameter compared to the wireline cable of FIG. 2A;

FIG. 3A is an enlarged transverse cross-section of an uncompressed stranded electrical wire of FIG. 2A;

FIG. 3B is an enlarged transverse cross-section of a compressed stranded electrical wire of FIG. 2B according to an embodiment;

FIG. 4 is a flowchart of a method for conducting a wireline operation according to an embodiment; and

FIG. 5 is a transverse cross-section of a seven-conductor wireline cable of according to an embodiment having six electrical wires with compressed strands wound about a central strength member.

### DETAILED DESCRIPTION

The present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper,” “uphole,” “downhole,” “upstream,” “downstream,” and the like, may be used herein for ease of description to describe one element or feature's relationship to another element(s) or feature(s) as illustrated in the figures. The spatially relative terms are intended to encompass different orientations of the apparatus in use or operation in addition to the orientation depicted in the figures.

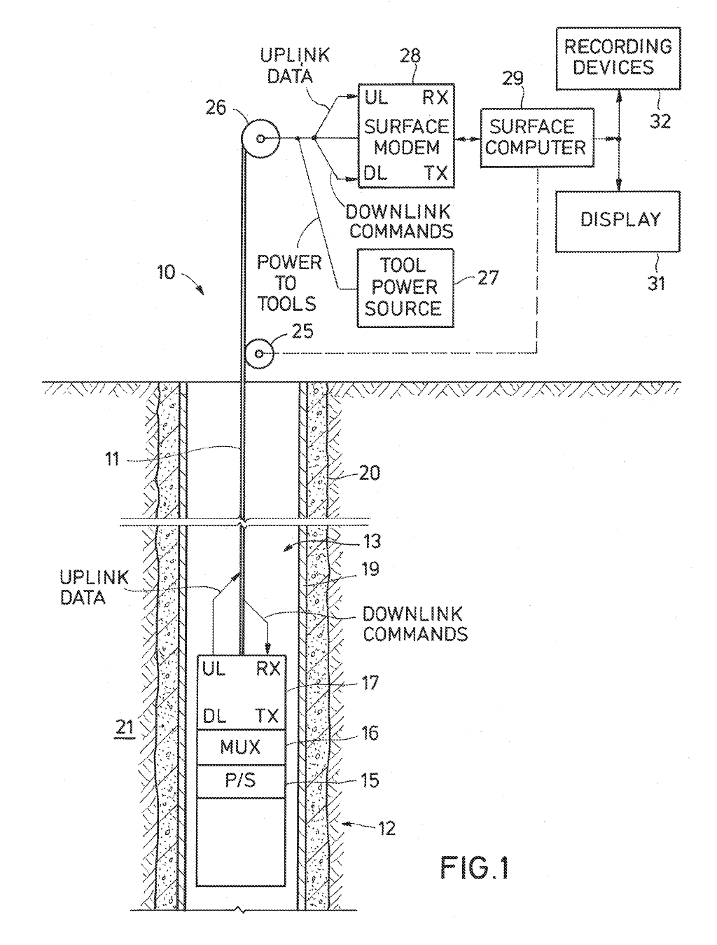

FIG. 1 shows a system view of a wireline system 10 according to one or more embodiments.

A wireline cable 11 suspends a wireline tool 12 in a wellbore 13. Wellbore 13 may be lined with casing 19 and a cement sheath 20, or wellbore 13 may be open hole (not illustrated). Wellbore 13 can be any depth, and the length of wireline cable 11 should be sufficient for the depth of wellbore 13. Wireline system 10 may include a sheave 25 which may be used in guiding the wireline cable 11 into wellbore 13. Wireline cable 11 may be spooled on a cable reel 26 or drum for storage. Wireline cable 11 may be structurally connected with wireline tool 12 and payed out or taken in to raise and lower wireline tool 12 in wellbore 13.

Wireline tool 12 may have a protective shell or housing which may be fluid tight and pressure resistant to enable the equipment within the interior to be supported and protected during deployment. Wireline tool 12 may enclose one or more logging tools which generate data useful in analysis of wellbore 13 or in determining the nature of the formation 21 in which wellbore 13 is located. However, other types of tools, including fishing tools, coring tools, and testing tools may be used.

Wireline tool 12 may also enclose a power supply 15. Output data streams one or more detectors may be provided to a multiplexer 16 located in wireline tool 12. Wireline tool 12 may also include a communication module 17 having an uplink communication device, a downlink communication device, a data transmitter, and a data receiver.

One or more electrical wires in wireline cable 11 may be connected with surface-located equipment, which may include a power source 27 to provide power to tool power supply 15, a surface communication module 28 having an uplink communication device, a downlink communication device, a data transmitter and also a data receiver, a surface computer 29, a display 31, and one or more recording devices 32. Sheave 25 may be connected by a suitable sensor to an input of surface computer 29 to provide depth measuring information.

Wireline cable 11 may be an electromechanical cable which may perform several basic functions: mechanically support its own weight and the weight of wireline tool(s) carried thereby, provide crush resistance for spooling, provide electrical power to the wireline tool(s), provide electrical communications between the surface and the wireline tool(s), allow for depth measurement, and prevent fluid flow through interstitial voids in the cable. Wireline cable 11 may also include optical fibers and hydraulic conduits for communications, control, and/or power. Wireline cable 11 may constructed of materials having properties to withstand the high temperatures and harsh chemical environments that may be encountered downhole.

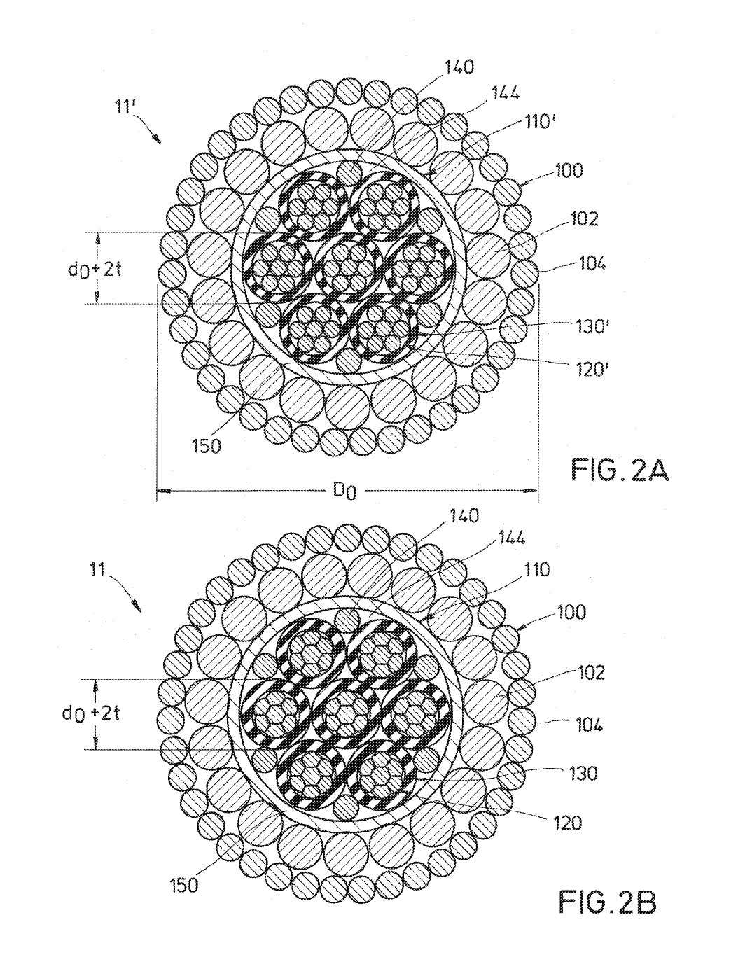

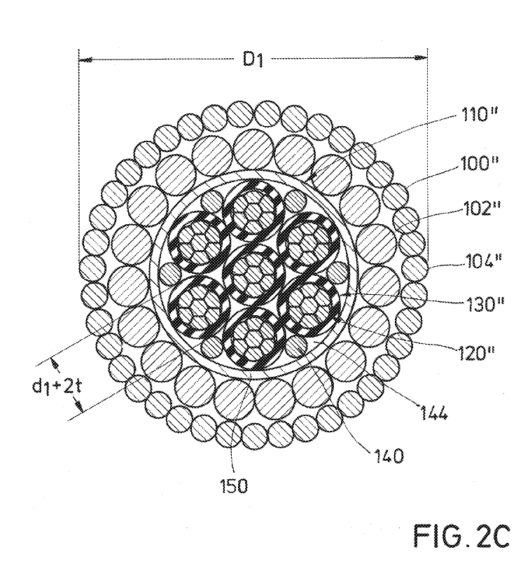

FIG. 2B is a transverse cross-section of a wireline cable 11 according to one or more embodiments. Wireline cable may include a strength member 100. A primary function of strength member 100 is to provide the physical strength to carry the weight of the cable itself, heavy tool and or strings that may be carried by the wireline cable, and to withstand the added stress and dynamic loads, for example, during attempts to free stuck tools.

Strength member 100 may include an armor package of one or more layers of armor wire wound or braided about a jacketed cable core 110. The armor package also serves to protect cable core 110. In the embodiment of FIG. 2B, an inner armor layer 102 and an outer armor layer 104 are shown. However, a greater or lesser number of armor layers may be provided as appropriate. Inner armor layer 102 may be helically wound in a first direction about cable core 110, and outer armor layer 104 may be helically wound about inner armor layer 102 in the opposite direction to reduce preloaded torque and compressive forces. That is, torque forces are principally applied to outer armor layer 104. These torque forces compress inner armor layer 102. However, the inner armor may be contra-helically wound to oppose the compression. The lay angle, number, and size of the armor wire for each layer of the armor package may be carefully selected to balance torque and provide required tensile strength and crush resistance.

Inner and outer armor layers 102, 104 may be constructed of improved plow steel (IPS), which provides good wear characteristics, strength and ductility. However, other suitable materials, including braided aramid fibers, may be used for armor. Moreover, in one or more embodiments, strength member 100 may include a tensile member (not illustrated) centrally, axially, or helically disposed within the jacketed cable core 110, either in lieu of or in addition to an external armor package.

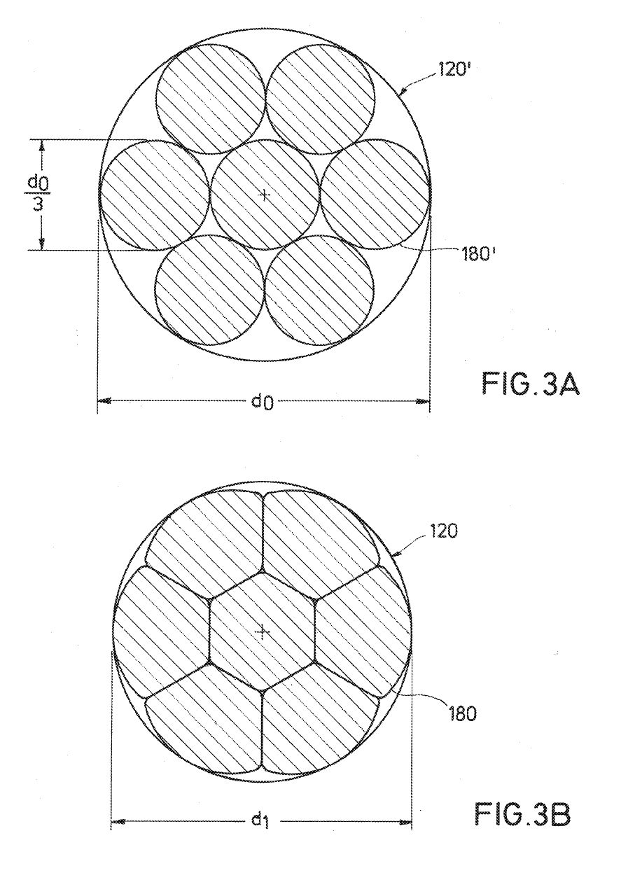

Wireline cable 11 may include one or more electrical wires 120. Electrical wires 120 may be made of copper or aluminum, for example. Copper conductors may also have a nickel coating for high temperature use. Because the stretch coefficient of copper wire is much lower than the stretch of a double-helix armored wireline cable 11, electrical wires 120 may be formed of stranded copper rather than solid conductors to prevent breakage. In some embodiments, one or more electrical wires 120 may have a compacted strand conductor, as described in greater detail hereinafter with respect to FIG. 3B.

Electrical wires 120 may serve the dual purpose of providing adequate electrical power from the surface to the downhole wireline tool 12 (FIG. 1) and to provide one or more telemetry channels for command, control, and data transfer. Electrical wires must be large enough to supply adequate electrical current at a required voltage at the wireline tool and to communicate electrical telemetry signals with minimal distortion. As some telemetry schemes require balanced channels, electrical wires 120 are ideally formed to hold a consistent electrical resistance per unit length.

Each electrical wire 120 may have a dielectric insulating layer 130 formed thereabout, such as by an extrusion process. The purpose of dielectric layer 130 is to provide electrical isolation between multiple wires 120. There are many available types of insulating material. The properties of the insulating material may be a primary factor in determining the upper temperature operating limit of wireline cable 11. When temperature limits are exceeded the insulating material may become fluid and allow the electrical wire to short. Also, as the insulating material becomes fluid or approaches a fluid state, foreign material may become damage the integrity of the insulator. This foreign material may penetrate to the conductor and cause leakage immediately or at a later date time when additional runs and stress are applied to wireline cable 11. Additionally, the type and thickness of the insulating material is related to capacitance between a pair of electrical wires 120. Increased thickness of dielectric layer 130 reduces the capacitance and therefore increases the distance that telemetry can traverse.

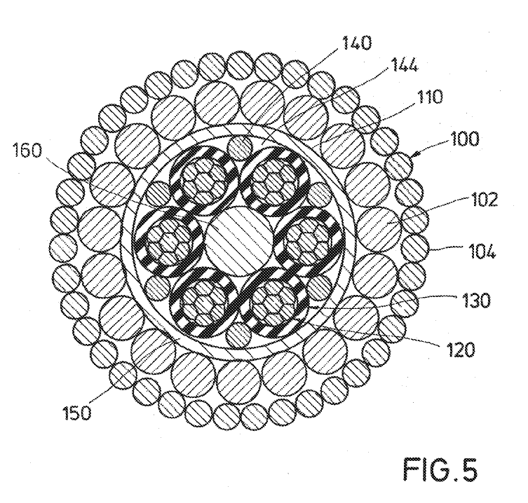

In the embodiment of FIG. 2B, wireline cable 11 includes seven insulated electrical wires 120 each having a compacted strand conductor. Six electrical wires 120 may be helically wound about the central seventh electrical wire 120. In one or more embodiments, the seventh central electrical wire may be replaced by a central strength member 160, as illustrated in FIG. 5. Cable core 110 may also include other components, such as fillers, hollow tubes, and fiber optic wires. These optional components are shown generically in FIG. 2B by reference numeral 140. Such components may take the place of one or more electrical wires 120, may be helically wound in a separate circumferential layer, or as shown in FIG. 2B, may be disposed in interstitial spaces between electrical wires 120.

As electrical wires 120 and other components are wound to form cable core 110, a water-blocking compound 144, such as a grease, silicone, or the like, may be added to fill any interstitial void spaces. A binder (not expressly illustrated), such as a fiber, cloth, or Kapton® tape may simultaneously be wrapped about cable core 110 to contain water-blocking compound 144 as it cures. Water blocking compound 144 may act somewhat like a lubricant that allows the six helically-wound electrical wires 120 to slide along the central electrical wire 120 to relieve tension due to bending of wireline cable 11 during operations such the cable passing over sheave 25 wound about winch 26.

Finally, a jacket 150, which may be elastomeric, polymeric, for example, may be formed about cable core 110, such as by an extrusion process. Jacketing 150 may protect the electric wire dielectric layers 130 from being rubbed and chaffed by inner armor layer 102.

Although a 1×7 cable configuration is illustrated in FIG. 2B, any other cable configuration having at least one electrical wire 120 with a compacted strand may be used based on the requirements of a particular wireline operation. Moreover, although electrical wires 120 are illustrated in FIG. 2B as each having a 1×7 compacted strand, other compacted strand configurations may be used for electrical wires 120.

FIG. 3A is an enlarged transverse cross-section of a typical 1×7 uncompressed stranded electrical wire 120′, such as used in the wireline cable 11′ of FIG. 2A. FIG. 3B is an enlarged transverse cross-section of a 1×7 compressed stranded electrical wire 120 of FIG. 2B according to one or more embodiments. Each electrical wire 120, 120′ has six wire strands 180, 180′ helically wound about a center seventh wire strand 180, 180′. Each wire strand 180, 180′ of diameter

$$\frac{{d}_{0}}{3}$$

has the same conductive cross-sectional area of

$$\frac{π {d}_{0}^{2}}{36} .$$

Accordingly, each stranded electrical wire 120, 120′ has the same cross-sectional area of conductive material of

$$\frac{7 π {d}_{0}^{2}}{36} .$$

It is readily determinable that for a wire strand 180′ of diameter

$$\frac{{d}_{0}}{3} ,$$

the outer diameter of electrical wire 120′ is d₀, and the total percentage of the overall cross-sectional area

$$\frac{π {d}_{0}^{2}}{4}$$

of wire 120′ that is consumed by interstitial voids between the strands 180′ is approximately 22 percent.

According to an embodiment, wire 120 is characterized by a compressed strand that reduces its outer diameter d₁ to less than d₀ of uncompressed wire 120′ and reduces the percentage of the overall cross-sectional area of wire 120 that is consumed by interstitial voids between the strands 180 to a value less than 12 percent, and in some cases, to about 9 percent.

In one or more embodiments, compacted electrical wire 120 may be formed by first forming uncompacted electrical wire 120′ and thereafter compressing the wire, for example, by swaging the wire through rollers or dies to reshape the outer layer of wire strands and fill interstitial voids. In particular, the outer layer of strands 180 have been reshaped to have generally trapezoidal shapes. However, in one or more embodiments, compacted electrical wire 120 may be formed by first forming wire strands 180 into a desired trapezoidal shape and then helically winding the trapezoidal strands about a center strand. In one or more embodiments, a combination of the above processes may be used to form electrical wire 120. In either process, a water-blocking compound may be used to fill remaining interstitial voids between the strands. Regardless of the manufacturing process used, care must be taken to ensure consistent compaction and cross-sectional area along the length of electrical wire 120 so as to provide conductors with matched electrical resistances for power and telemetry purposes. In one or more embodiments, electrical balance is maintained between wires 120 to within 4 percent, and preferably to within 1 percent.

Referring to FIG. 2A, conventional wireline cable 11′ may have seven electrical wires 120′ with uncompressed strands, each defining a conductive cross sectional area of

$$\frac{π {d}_{0}^{2}}{36}$$

and an outer diameter of d₀. Each electrical wire 120′ may be insulated with dielectric layer 130′ of thickness t. Accordingly, the outer diameter of dielectric layer 130′ is d₀+2t. The outer diameter of conventional wireline cable 11′ is D₀.

Similarly, referring to FIG. 2B, wireline cable 11 of FIG. 2B may include seven electrical wires 120 of conductive cross sectional area of

$$\frac{π {d}_{0}^{2}}{36} .$$

However, electrical wires 120 have compacted strands and an outer diameter d₁ less than d₀. Each electrical wire 120 is insulated with dielectric layer 130. Because of the reduced diameters d₁, dielectric layers 130 may be greater by

$$\frac{{d}_{0} - {d}_{1}}{2}$$

than the than the thickness t of dielectric layer 130′ while still maintaining the outer diameter of dielectric layer 130 at d₀+2t. Thus, the same cable core diameter may result, and the same armor package may be used to maintain the outer diameter of wireline cable 11 at D₀.

Due to thicker electrical insulation, wireline cable 11 is characterized by lower capacitance than conventional wireline cable 11′. Because capacitance is significant limitation on telemetry, wireline cable 11 may therefore be able to transmit telemetry across greater distances. The thicker dielectric layers 130 may also make wireline cable 11 less apt to arc under the stress of applied voltages and therefore suitable for operating under higher voltage. Moreover, thicker dielectric layers 130 may reduce “drum crush” damage, where an electrical wire 120 becomes shorted due to compression of the armor package and subsequent cold flow of the insulation material.

Referring to FIGS. 2A and 2C, wireline cable 11″ of FIG. 2C may also include seven electrical wires 120 having compacted strands and providing the same conductor cross-sectional area as conventional wireline cable 11′. Similarly, dielectric layers 130″ may have the same thickness t as dielectric layers 130′ of wireline cable 11′. However, the outer diameters of dielectric layers 130″, d₁+2t, are less than the outer diameters, d₀+2t, of dielectric layers 130′. Accordingly, the armor package may be reduced and the overall diameter D₁ and weight of wireline cable 11″ may be less than the overall diameter D₀ and weight of conventional wireline cable 11′.

Pressure control in cased-hole wireline operations may be limited by the size of the wireline cable, due primarily to voids in the armor package. Accordingly, the reduced size of wireline cable 11″ of FIG. 2C may enhance pressure control compared wireline cable 11′ of FIG. 2A. Alternatively, the smaller cable core 110″ of FIG. 2C may be provided with a larger, stronger armor package (not illustrated) than that of conventional wireline cable 11′, resulting in a stronger wireline cable having the same overall outer diameter D₀ as conventional wireline cable 11′ of FIG. 2A.

In one or more embodiments, by using electrical wires 120 with compacted strands, additional conductor cross-sectional area could be provided within a wireline cable having about the same outer diameter D₀ as conventional wireline cable 11′, thereby lowering overall electrical resistance per unit length. To illustrate, an uncompacted copper strand electrical wire 120′ having a 7×0.0128″ configuration (six copper strands of diameter 0.0128″ helically wrapped around a seventh central copper strand of diameter 0.0128″ and defining an overall diameter d₀ of 0.0384″) may have an electrical resistance of about 9.8 ohms/kft. A copper strand electrical wire 120 formed from a 7×0.0138″ configuration may be compacted to the same diameter d₀ of 0.0384″ yet have a decreased electrical resistance of 8.4 ohms/kft. Further, a copper strand electrical wire 120 formed from a 7×0.0172″ configuration may be compacted to an overall diameter of 0.0485″ and have a decreased electrical resistance of 5.4 ohms/kft. As a result, I²R losses an concomitant heating of wireline cable 11 may be reduced, and voltage necessary at the surface of wellbore 13 necessary to supply a required voltage to wireline tool 12 (FIG. 1) may be reduced for a given depth.

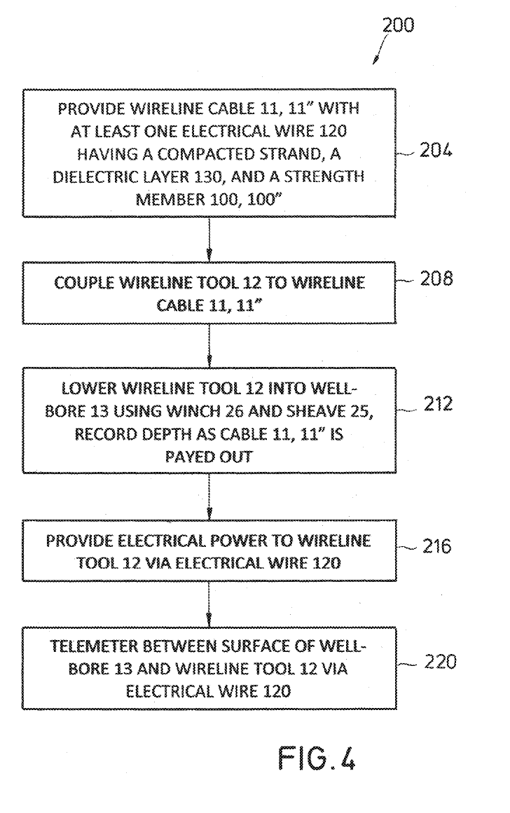

FIG. 4 illustrates a method 200 for wireline operations. Referring to FIGS. 2B, 2C, and 4, at step 204, a wireline cable 11, 11″ including a first electrical wire 120 having a compact stranded conductor, a first dielectric layer 130 formed about said first electrical wire, and a strength member 100 is provided. In particular, because of the compact stranded conductor, the above-described improvements—increasing conductor size, increasing dielectric layer thickness, increasing armor size, and decreasing cable outer diameter—may be varied and optimized to provide specific wireline cable designs for particular wireline purposes. As compared to a conventional wireline cable employing uncompacted stranded conductors, the electrical resistance of the wireline cable may be lowered, the capacitance may be lowered, the operating temperature may be lowered, the outer diameter and weight may be lowered, and/or the tensile strength may be increased.

At step 208, wireline tool 12 (FIG. 1) may be mechanically and electrically coupled to wireline cable 11, 11″, and at step 212, wireline tool 12 may be lowered into wellbore 13 using winch 26 and sheave 25. As wireline tool 12 is lowered, the amount of wireline cable 11, 11″ payed out may be recorded to determine depth of wireline tool 12 within wellbore 13.

At steps 216 and 220, electrical power is provided to wireline tool 12 via electrical wires 120, and telemetry is transmitted between wireline tool 12 and the surface of wellbore 13 via electrical wires 120. With a decreased electrical resistance, the voltage applied at the surface of wellbore 13 may be reduced and/or power transmitted over greater distances. Similarly, with a decreased capacitance and/or resistance, telemetry may be reliably transmitted over greater distances.

In summary, a wireline system, a method for wireline operations, and a wireline cable have been described. Embodiments of the wireline system may generally have: A wireline cable including a first electrical wire having a compact stranded conductor, a first dielectric layer formed about the first electrical wire, and a strength member; a winch, a portion of the wireline cable spooled on the winch; and a wireline tool electrically coupled to a first end of the wireline cable and carried by the strength member. Embodiments of the method for wireline operations may generally include: Providing a wireline cable including a first electrical wire having a compact stranded conductor, a first dielectric layer formed about the first electrical wire, and a strength member; suspending a wireline tool by the wireline cable; lowering the wireline tool into a wellbore; and providing electrical power to the tool via the first electrical wire. In a wireline cable including a plurality of electrical wires each having an uncompacted stranded conductor characterized by an original outer diameter d₀ and an original conductive cross-sectional area A₀, a dielectric layer of outer diameter d₀+2t formed about each the electrical wire, the plurality of electrical wires helically wound to form a cable core, and an armor package formed about the cable core and defining an original cable outer diameter D₀, embodiments of an improved wireline cable may generally have at least one of the group consisting of: a first of the plurality of electrical wires having a compacted stranded conductor characterized by compacted conductive cross-sectional area A₁ greater than the original conductive cross-sectional area A₀; and a second of the plurality of electrical wires having a compacted stranded conductor characterized by a compacted outer diameter d₁ less than the original outer diameter d₀. Embodiments of a wireline cable may also include: A first electrical wire having a compact stranded conductor with a generally circular cross-section and formed of a plurality of helically-wound metallic wire strands having a generally non-circular cross-section; a first dielectric layer formed about the first electrical wire; and a strength member.

Any of the foregoing embodiments may include any one of the following elements or characteristics, alone or in combination with each other: The compact strand is characterized generally circular cross-section and formed of a plurality of helically-wound metallic wire strands, each of the plurality of helically-wound metallic wire strands characterized by a generally non-circular cross-section so as to minimize interstitial voids in the first electrical wire; the first electrical wire is formed of six the helically-wound metallic wire strands disposed about a seventh wire strand; the first electrical wire is formed of six circular wire strands wound about a seventh circular wire strand and thereafter swaged to compress the six circular wire strands and form the generally non-circular cross-sections; a second electrical wire characterized by a generally circular cross-section and formed of a plurality of helically-wound metallic wire strands, each of the plurality of helically-wound metallic strands characterized by a generally non-circular cross-section; a second dielectric layer formed about the second electrical wire; the first and second electrical wires being wound to form a cable core characterized by a generally circular cross-section; a jacket formed about the cable core; the second electrical wire is formed of six the wire helically strands wound about a seventh the wire strand; the first and second electrical wires are characterized by approximately balanced electrical resistances; an electrical resistance of the first electrical wire differs by no more than four percent of an electrical resistance of the second electrical wire; the strength member includes an armor layer disposed about the jacket.; the strength member includes an armor layer disposed about the first dielectric layer; the first and second electrical wires are formed of copper; third, fourth, fifth, sixth, and seventh electrical wires each characterized by a generally circular cross-section and formed of a plurality of helically-wound metallic wire strands, each of the plurality of helically-wound metallic strands characterized by a generally non-circular cross-section; third, fourth, fifth, sixth, and seventh dielectric layers formed about the third, fourth, fifth, sixth, and seventh electrical wires, respectively; the second, third, fourth, fifth, sixth, and seventh electrical wires being wound the first electrical wire to form the cable core; each of second, third, fourth, fifth, sixth, and seventh electrical conductors is formed of six the wire strands wound about a seventh the wire strand; providing the wireline cable having the first electrical wire characterized by a generally circular cross-section and formed of a plurality of helically-wound metallic wire strands, each of the plurality of helically-wound metallic strands characterized by a generally non-circular cross-section so as to minimize interstitial voids in the first electrical wire; providing the wireline cable having a second electrical wire characterized by a generally circular cross-section and formed of a plurality of helically-wound metallic wire strands, each of the plurality of helically-wound metallic wire strands characterized by a generally non-circular cross-section so as to minimize interstitial voids in the second electrical wire; telemetering between the wireline tool and a point located at the surface of the wellbore via the first and second electrical wires; winding six circular wire strands wound about a seventh circular wire strand to form a bare stranded wire defining an original diameter; swaging the bare stranded wire to have a compact diameter less than the original diameter; swaging bare stranded the wire to reduce a of ratio cross-sectional interstitial void area to total cross-sectional area of the bare stranded wire to less than 12%; balancing electrical resistances of the first and second electrical wires; the first and second electrical wires are copper; the first of the plurality of electrical wires is characterized by a compacted outer diameter d₁ approximately equal to the original outer diameter d₀; each of the plurality of electrical wires has a compacted stranded conductor characterized by a compacted conductive cross-sectional area A₁ greater than the original conductive cross-sectional area A₀; the armor package formed about the cable core defines an wireline cable outer diameter D₁ approximately equal to the original cable outer diameter D₀; the second of the plurality of electrical wires is characterized by a compacted conductive cross-sectional area A₁ approximately equal to the original conductive cross-sectional area A₀; the dielectric layer formed about the second of the plurality of electrical wires has an outer diameter of d₀+2t; the dielectric layer formed about the second of the plurality of electrical wires has an outer diameter of d₁+2t; each of the plurality of electrical wires has a compacted stranded conductor characterized by a compacted outer diameter d₁ less than the original outer diameter do; the dielectric layers formed about the plurality of electrical wires have outer diameters of d₀+2t; the armor package formed about the cable core defines an wireline cable outer diameter D₁ approximately equal to the original cable outer diameter D₀; the dielectric layers formed about the plurality of electrical wires have outer diameters of d₁+2t; and the armor package formed about the cable core defines an wireline cable outer diameter D₁ less than the original cable outer diameter D₀; the strength member surrounds the first electrical wire; the strength member is adjacent the first electrical wire; and an armor layer surrounding the strength member and the first electrical wire.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

1. A wireline system comprising:
a wireline cable including a first electrical wire having a compact stranded conductor, a first dielectric layer formed about said first electrical wire, and a strength member;
a winch, a portion of said wireline cable spooled on said winch; and
a wireline tool electrically coupled to a first end of said wireline cable and carried by said strength member.

2. The wireline system of claim 1 wherein:
said compact stranded conductor is characterized by a generally circular cross-section and formed of a plurality of helically-wound metallic wire strands, each of said plurality of helically-wound metallic wire strands characterized by a generally non-circular cross-section so as to minimize interstitial voids in said first electrical wire.

3. The wireline system of claim 2 wherein:
said first electrical wire is formed of six said helically-wound metallic wire strands disposed about a seventh wire strand.

4. The wireline system of claim 3 wherein:
said first electrical wire is formed of six circular wire strands wound about a seventh circular wire strand and thereafter swaged to compress said six circular wire strands and form said generally non-circular cross-sections.

5. The wireline system of claim 1 wherein said wireline cable further comprises:
a second electrical wire characterized by a generally circular cross-section and formed of a plurality of helically-wound metallic wire strands, each of said plurality of helically-wound metallic strands characterized by a generally non-circular cross-section;
a second dielectric layer formed about said second electrical wire;
said first and second electrical wires being wound to form a cable core characterized by a generally circular cross-section; and
a jacket formed about said cable core.

6. The wireline system of claim 5 wherein:
said second electrical wire is formed of six said wire helically strands wound about a seventh said wire strand; and
said first and second electrical wires are characterized by approximately balanced electrical resistances.

7. The wireline system of claim 6 wherein:
an electrical resistance of said first electrical wire differs by no more than four percent of an electrical resistance of said second electrical wire.

8. The wireline system of claim 5 wherein:
said strength member includes an armor layer disposed about said jacket.

9. The wireline system of claim 1 wherein:
said strength member includes an armor layer disposed about said first dielectric layer.

10. The wireline system of claim 5 wherein:
said first and second electrical wires are formed of copper.

11. The wireline system of claim 5 wherein said wireline cable further comprises:
third, fourth, fifth, sixth, and seventh electrical wires each characterized by a generally circular cross-section and formed of a plurality of helically-wound metallic wire strands, each of said plurality of helically-wound metallic strands characterized by a generally non-circular cross-section; and
third, fourth, fifth, sixth, and seventh dielectric layers formed about said third, fourth, fifth, sixth, and seventh electrical wires, respectively;
said second, third, fourth, fifth, sixth, and seventh electrical wires being wound said first electrical wire to form said cable core.

12. The wireline system of claim 11 wherein:
each of second, third, fourth, fifth, sixth, and seventh electrical conductors is formed of six said wire strands wound about a seventh said wire strand.

13. A method for wireline operations, comprising:
providing a wireline cable including a first electrical wire having a compact stranded conductor, a first dielectric layer formed about said first electrical wire, and a strength member;
suspending a wireline tool by said wireline cable;
lowering said wireline tool into a wellbore; and
providing electrical power to said tool via said first electrical wire.

14. The method of claim 13 further comprising:
providing said wireline cable having said first electrical wire characterized by a generally circular cross-section and formed of a plurality of helically-wound metallic wire strands, each of said plurality of helically-wound metallic strands characterized by a generally non-circular cross-section so as to minimize interstitial voids in said first electrical wire.

15. The method of claim 13 further comprising:
providing said wireline cable having a second electrical wire characterized by a generally circular cross-section and formed of a plurality of helically-wound metallic wire strands, each of said plurality of helically-wound metallic wire strands characterized by a generally non-circular cross-section so as to minimize interstitial voids in said second electrical wire; and
telemetering between said wireline tool and a point located at the surface of said wellbore via said first and second electrical wires.

16. The method of claim 15 wherein providing said first and second electrical wires comprises:
winding six circular wire strands wound about a seventh circular wire strand to form a bare stranded wire defining an original diameter; and then swaging said bare stranded wire to have a compact diameter less than said original diameter.

17. The method of claim 16 wherein providing said first and second electrical wires further comprises:
swaging said bare stranded wire to reduce a ratio of cross-sectional interstitial void area to total cross-sectional area of said bare stranded wire to less than 12%.

18. The method of claim 16 wherein providing said first and second electrical wires further comprises:
balancing electrical resistances of said first and second electrical wires.

19. The method of claim 16 wherein:
said first and second electrical wires are copper.

20. In a wireline cable including a plurality of electrical wires each having an uncompacted stranded conductor characterized by an original outer diameter d₀ and an original conductive cross-sectional area A₀, a dielectric layer of outer diameter d₀+2t formed about each said electrical wire, said plurality of electrical wires helically wound to form a cable core, and an armor package formed about said cable core and defining an original cable outer diameter D₀, an improvement comprising at least one of the group consisting of:
(a) a first of said plurality of electrical wires having a compacted stranded conductor characterized by compacted conductive cross-sectional area A₁ greater than said original conductive cross-sectional area A₀; and
(b) a second of said plurality of electrical wires having a compacted stranded conductor characterized by a compacted outer diameter d₁ less than said original outer diameter d₀.

21. The wireline cable of claim 20 wherein:
said first of said plurality of electrical wires is characterized by a compacted outer diameter d₁ approximately equal to said original outer diameter d₀.

22. The wireline cable of claim 20 wherein:
each of said plurality of electrical wires has a compacted stranded conductor characterized by a compacted conductive cross-sectional area A₁ greater than said original conductive cross-sectional area A₀.

23. The wireline cable of claim 22 wherein:
said armor package formed about said cable core defines an wireline cable outer diameter D₁ approximately equal to said original cable outer diameter D₀.

24. The wireline cable of claim 20 wherein:
said second of said plurality of electrical wires is characterized by a compacted conductive cross-sectional area A₁ approximately equal to said original conductive cross-sectional area A₀.

25. The wireline cable of claim 20 wherein:
said dielectric layer formed about said second of said plurality of electrical wires has an outer diameter of d₀+2t.

26. The wireline cable of claim 20 wherein:
said dielectric layer formed about said second of said plurality of electrical wires has an outer diameter of d₁+2t.

27. The wireline cable of claim 20 wherein:
each of said plurality of electrical wires has a compacted stranded conductor characterized by a compacted outer diameter d₁ less than said original outer diameter d₀;
said dielectric layers formed about said plurality of electrical wires have outer diameters of d₀+2t; and
said armor package formed about said cable core defines an wireline cable outer diameter D₁ approximately equal to said original cable outer diameter D₀.

28. The wireline cable of claim 20 wherein:
each of said plurality of electrical wires has a compacted stranded conductor characterized by a compacted outer diameter d₁ less than said original outer diameter d₀;
said dielectric layers formed about said plurality of electrical wires have outer diameters of d₁+2t; and
said armor package formed about said cable core defines an wireline cable outer diameter D₁ less than said original cable outer diameter D₀.

29. The wireline cable of claim 20 wherein:
each of said plurality of electrical wires has a compacted stranded conductor characterized by a compacted outer diameter d₁ less than said original outer diameter d₀;
said dielectric layers formed about said plurality of electrical wires have outer diameters of d₁+2t; and
said armor package formed about said cable core defines an wireline cable outer diameter D₁ approximately equal to said original cable outer diameter D₀.

30. A wireline cable for downhole use, comprising:
a first electrical wire having a compact stranded conductor with a generally circular cross-section and formed of a plurality of helically-wound metallic wire strands having a generally non-circular cross-section;
a first dielectric layer formed about said first electrical wire; and
a strength member.

31. The wireline cable of claim 30 wherein:
said strength member surrounds the first electrical wire.

32. The wireline cable of claim 30 wherein:
said strength member is adjacent the first electrical wire; and
the wireline cable further includes an armor layer surrounding the strength member and the first electrical wire.
